(19) United States
(12) Patent Application Publication
(10) Pub. No.: US 2017/0124565 A1
(43) Pub. Date: May 4, 2017

(54) METHODS AND APPARATUS FOR PROCESSING AND AUTHENTICATING MOBILE PAYMENT TRANSACTIONS

(71) Applicant: MasterCard International Incorporated, Purchase, NY (US)

(72) Inventors: Hemant Arora, Gurgaon (IN); Jaipal Singh Kumawat, Gurgaon (IN); Gurpreet Atwal, Somers, NY (US)

(21) Appl. No.: 15/299,857

(22) Filed: Oct. 21, 2016

(30) Foreign Application Priority Data
Oct. 29, 2015 (SG) 10201508930Q

(51) Int. Cl. G06Q 20/40; G06Q 20/36; G06Q 20/10

(52) U.S. Cl. CPC G06Q 20/409; G06Q 20/102; G06Q 20/3674

(57) ABSTRACT

A computer implemented method of processing a mobile payment transaction is disclosed. The method comprises: receiving a mobile payment authorization request, the mobile payment authorization request indicating authentication information and an identifier of a payment card associated with the transaction, the authentication information comprising a device identifier of a payer device; comparing authentication information with stored authentication information associated with the payment card; and generating an authorization message for the mobile payment if the authentication information matches the stored authentication information associated with the payment card.

### CROSS-REFERENCE TO RELATED APPLICATION

This application is a U.S. National Stage filing under 35 U.S.C. §119, based on and claiming benefit of and priority to SG Patent Application No. 10201508930Q filed Oct. 29, 2015.

### TECHNICAL FIELD AND BACKGROUND

The present disclosure relates to a mobile payment transaction processing. In particular, it relates to the authentication of mobile payment transactions made using a mobile wallet.

Mobile payments using a mobile wallet typically involve a user registering details of a payment card on a mobile device. The mobile device stores a mobile wallet which can be used to make payments using the payment card. In a typical mobile wallet payment transaction, a consumer presents their mobile device which provides details of the payment card to the merchant. The merchant then uses this information to authorize the transaction.

The detection and prevention of fraud in mobile payments is becoming more important as the use of mobile payments grows. Therefore it is desirable to provide methods and systems for processing and authenticating mobile payment transactions that provide for the detection of fraudulent transactions.

### SUMMARY

In general terms, the present disclosure proposes methods and systems in which in addition to payment card details, an identifier of a user's mobile device is also registered as part of a mobile wallet registration process. In order to authenticate a mobile wallet transaction, the identity of the mobile device involved in the transaction is compared with information indicating a device or devices registered for use with a mobile wallet.

According to a first aspect of the present invention, there is provided a computer implemented method of processing a mobile payment transaction. The method comprises: receiving a mobile payment authorization request, the mobile payment authorization request indicating authentication information and an identifier of a payment card associated with the transaction, the authentication information comprising a device identifier of a payer device; comparing authentication information with stored authentication information associated with the payment card; and generating an authorization message for the mobile payment if the authentication information matches the stored authentication information associated with the payment card.

In an embodiment, the identifier of the payer device is a MAC address of the payer device. A Media Access Control (MAC) address is a globally unique identifier assigned to network devices. Each network device has a unique MAC address which is assigned when the device is manufactured. This means that unlike internet protocol (IP) addresses which may change over time, MAC addresses remain the same for a given device.

In an embodiment the mobile payment request is formatted according to the ISO-8583 standard. The ISO-8583 standard relates to systems that exchange data concerning electronic transactions made by cardholders using payment cards. In an embodiment, the device identifier of the payer device is indicated in a data field of the mobile payment authorization request configured for private use. According to the ISO-8583 standard, the data fields 61to 63, or 120 to 127 are allocated for private use.

In an embodiment, the method comprises generating a fraud alert if the authentication information does not match the stored authentication information associated with the payment card.

In an embodiment, stored authentication information associated with the payment card comprises an identifier of a first device marked as active and an identifier of a second device marked as non-active and the method comprises comparing the identifier of the payer device with the identifier of the first device.

The method may be implemented by, for example, a server having a computer processor and data storage device storing software components or instructions to carry out the operations disclosed above.

According to a second aspect of the present invention, there is provided a non-transitory computer-readable medium. The computer-readable medium has stored thereon program instructions for causing at least one processor to perform operations of a method disclosed above.

According to a third aspect of the present invention, there is provided a method, in a server of a mobile payment transaction processing system, of generating authentication information for authorizing mobile payment transactions. The method comprises receiving a mobile wallet registration request from a user device, the mobile wallet registration request comprising an identifier of a payment card to be associated with the mobile wallet; determining a device identifier of the user device; and storing the device identifier of the user device as authentication information associated with the payment card.

In an embodiment the device identifier of the user device is determined by sending an indication of a web address to the user device and the device identifier of the user device is determined as the identifier of a device visiting the web address. The web address may be sent as a text message containing the web address.

In an embodiment, the identifier of the user device is a MAC address of the user device.

According to a yet further aspect, there is provided a non-transitory computer-readable medium. The computer-readable medium has stored thereon program instructions for causing at least one processor to perform operations of a method disclosed above.

According to a further aspect of the present invention, there is provided an apparatus for processing a mobile payment transaction. The apparatus comprises: a computer processor and a data storage device, the data storage device having a mobile wallet payment authorization component comprising non-transitory instructions operative by the processor to: receive a mobile payment authorization request, the mobile payment authorization request indicating authentication information and an identifier of a payment card associated with the transaction, the authentication information comprising a device identifier of a payer device; compare authentication information with stored authentication information associated with the payment card; and generate an authorization message for the mobile payment if the authentication information matches the stored authentication information associated with the payment card.

### BRIEF DESCRIPTION OF THE DRAWINGS

Embodiments of the invention will now be described for the sake of non-limiting example only, with reference to the following drawings in which:

FIG. 1 illustrates an apparatus according to an embodiment;

FIG. 2 is a block diagram illustrating a technical architecture of the apparatus according to an embodiment;

FIG. 3 is a flow diagram illustrating process steps which are performed by the system of FIG. 1 during a method of authenticating a mobile payment transaction; and

FIG. 4 is a flow diagram illustrating process steps which are performed by the system of FIG. 1 during a method of registering mobile wallet authentication information.

### DETAILED DESCRIPTION

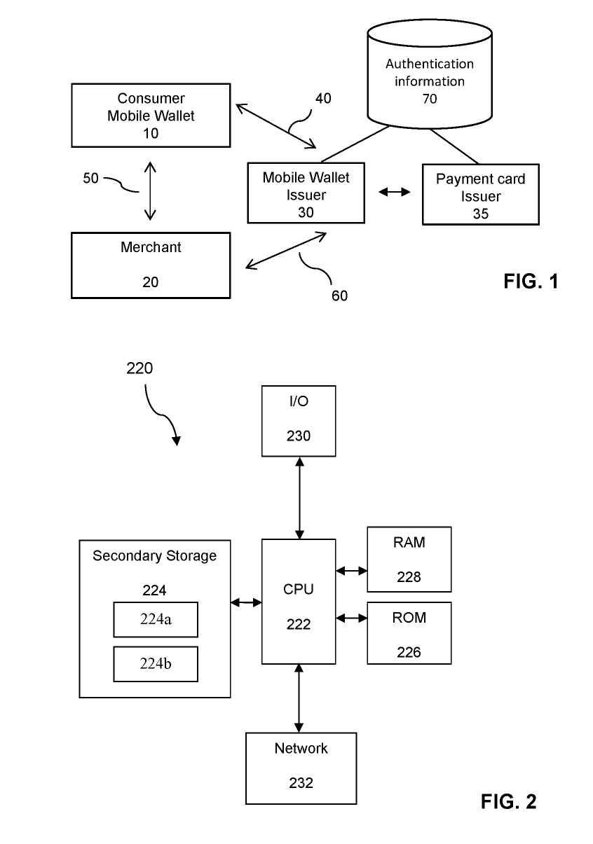

FIG. 1 illustrates an apparatus for processing mobile payment transactions between a consumer having a device 10 which may be for example a mobile telephone or tablet device that acts as a mobile wallet, a merchant terminal 20, a mobile payment transaction server 30 of the mobile wallet issuer, and a payment transaction server 35 of the payment card issuer.

Before carrying out a mobile payment, the consumer registers the mobile wallet 10 with the mobile payment transaction server 30 of the wallet issuer. During the registration process, the consumer device 10 provides information 40, including payment card details and an identifier of the consumer device to the mobile payment transaction server 30. The mobile payment transaction server 30 is coupled to storage 70 for authentication information. The mobile payment transaction server 30 stores the information 40 received during the registration process in the storage 70.

In the embodiment shown in FIG. 1, payment transaction server 35 of the payment card issuer can also access the storage 70 which stores the authentication information. In an alternative embodiment, the payment transaction server 35 of the payment card issuer is coupled to a separate storage which separately stores authentication information.

After registration, when a mobile payment transaction is carried out, the consumer device 10 provides information 50 to the merchant device 20. This information may be provided by a near field communication (NFC) link or other method of wireless communication. In order to authenticate the transaction, the merchant device 20 provides authentication information to the mobile payment transaction server 30 as part of a mobile payment authorization request 60. The mobile payment transaction server 30 compares the authentication information included in the payment authorization request 60 with the authentication information stored in the storage 70 to determine whether to authorize the payment request. The various communications may take place via any types of network, for example, virtual private network (VPN), the Internet, a local area and/or wide area network (LAN and/or WAN), and so on. The authentication information includes a device identifier such as the MAC address of the consumer mobile device 10. This device identifier is used to authorize the mobile payment transaction. The transaction may be converted to a Point of Sale (POS) type 82 transaction and sent to the 35 of the payment card issuer with the authentication information which includes an indication of the device identifier of the consumer device 10.

The transaction may also be authenticated by the payment transaction server 35 of the payment card issuer. The payment transaction server 35 of the payment card issuer compares the authentication information 40 which is received from the payment transaction server 30 of the mobile issuer with the stored authentication information to determine whether to authorize the payment request.

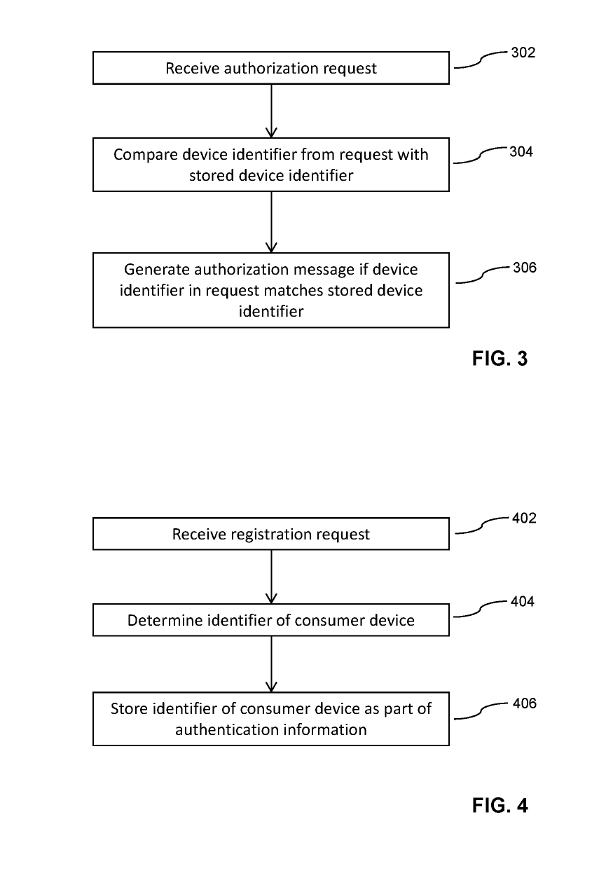

FIG. 2 is a block diagram showing a technical architecture of the mobile payment transaction server 30 for performing exemplary methods which are described below with reference to FIGS. 3 and 4. Typically, the methods are implemented by a computer having a data-processing unit. The block diagram as shown FIG. 2 illustrates a technical architecture 220 of a computer which is suitable for implementing one or more embodiments herein.

The technical architecture 220 includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture 220 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a mobile wallet registration component 224a, and a mobile wallet payment authorisation component 224b comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 220 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 220, at least one of the CPU 222, the RAM 228, and the ROM 226 are changed, transforming the technical architecture 220 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of the methods carried out by the mobile payment transaction server 30 will now be described with reference to FIGS. 3 and 4. FIG. 3 illustrates the authorisation of a transaction carried out between a consumer and a merchant. FIG. 4 illustrates a method of generating authentication information during the registration of a mobile wallet. It should be noted that enumeration of operations is for purposes of clarity and that the operations need not be performed in the order implied by the enumeration. FIG. 3 shows a method, carried out by the server 30, of authenticating a transaction carried out between a consumer 10 and a merchant 20. At step 302, the server 30 receives a mobile payment authorization request from the merchant 20. The mobile payment authorization request comprises an indication of the identifier of the consumer device 10. In an embodiment, the identifier of the consumer device comprises the media access code (MAC) address of the consumer device 10.

The request received in step 302 may comprise a data packet based on the ISO-8583 standard, although other suitable standards may also be adopted, depending on requirements of an intended application. The data packet is arranged to include identification data of the payment card stored in the mobile wallet on the consumer device 10, and the MAC address of the consumer device 10. When the data packet is formatted according to the ISO-8583 standard, the MAC address may be stored in a data field of the data packet that is configured for private use. According to the ISO-8583 standard, data fields 61to 63, and 120 to 127 are configured for private use.

At step 304, the mobile payment registration component 224b of the server 30 compares the device identifier of the consumer device 10 with stored device identifiers. Authentication information comprising device identifiers of devices registered for use by consumers is stored on the storage 70.

At step 306, if the device identifier of the consumer device 10 matches a stored device identifier registered for the payment card or mobile wallet making the transaction, the server 30 generates an authorization message to authorize the transaction.

In some embodiments, the server 30 generates a fraud alert if the device identifier received with in the authorization request does not match a stored device identifier. The fraud alert may be sent to the wallet issuer and/or the registered user of the mobile wallet.

In addition to the authorization using the device identifier the mobile payment may also be validated using biometric information such as a fingerprint of the consumer or an identity card number, a national security number or other information such as a permanent account number (PAN) which identifies the user. This additional validation may also involve cryptographic validation.

FIG. 4 shows a method carried out by the server 30 during registration of a mobile payment wallet stored on a consumer device 10.

At step 402, the server 30 receives a request from a consumer device 10 to register a mobile payment wallet. The request to register a mobile payment wallet may include personal identification information of the consumer and payment card details of the payment card or payment cards to be used with the payment wallet.

At step 404, the mobile wallet registration component 224a of the server 30 determines an identifier of the consumer device 10. In an embodiment, the identifier of the consumer device is the MAC address of the consumer device 10.

Step 404 may be implemented by the server 30 sending an indication of a website address to the consumer device 10. Step 404 may be implemented by the website indicated by the website address causing a application program interface (API) to run on the consumer device 10. The API would then identify the MAC address of the consumer device 10.

It is envisaged that a user may have the option to register more than one device with the same customer identity. Thus is a user has multiple devices, such as a smart phone and a tablet, the same wallet could be registered with the identifier of both devices. The consumer may have the option to de-register a device, this would allow for the situation where a user purchases a new device. The consumer may also be given the option to mark devices as active or non-active. Additionally, a time limit may be set by the mobile wallet provider so that if a device was not used to make a mobile payment for a certain period, for example 6 months, the device would be marked as non-active. This would reduce the processing required for the authentication as the details of the non-active devices would not have to be compared during the authentication process.

Whilst the foregoing description has described exemplary embodiments, it will be understood by those skilled in the art that many variations of the embodiment can be made within the scope and spirit of the present invention.

1. A computer implemented method of processing a mobile payment transaction, the method comprising:
receiving a mobile payment authorization request, the mobile payment authorization request indicating authentication information and an identifier of a payment card associated with the transaction, the authentication information comprising a device identifier of a payer device;
comparing the authentication information with stored authentication information associated with the payment card; and
generating an authorization message for the mobile payment if the authentication information matches the stored authentication information associated with the payment card.

2. A method according to claim 1, wherein the identifier of the payer device is a MAC address of the payer device.

3. A method according to claim 1, wherein the mobile payment request is formatted according to the ISO-8583 standard.

4. A method according to claim 3, wherein the device identifier of the payer device is indicated in a data field of the mobile payment authorization request configured for private use.

5. A method according to claim 4, wherein the data field is any one of data fields 61 to 63, or 120 to 127 defined by the ISO-8583 standard.

6. A method according to claim 1, further comprising generating a fraud alert if the authentication information does not match the stored authentication information associated with the payment card.

7. A method according to claim 1, wherein the stored authentication information associated with the payment card comprises an identifier of a first device marked as active and an identifier of a second device marked as non-active and the method comprises comparing the identifier of the payer device with the identifier of the first device.

8. A method, in a server of a mobile payment transaction processing system, of generating authentication information for authorizing mobile payment transactions, the method comprising:
receiving a mobile wallet registration request from a user device, the mobile wallet registration request comprising an identifier of a payment card to be associated with the mobile wallet;
determining a device identifier of the user device; and
storing the device identifier of the user device as authentication information associated with the payment card.

9. A method according to claim 8, wherein determining a device identifier of a user device comprises sending an indication of a web address to the user device and determining the device identifier of the user device as the identifier of a device visiting the web address.

10. A method according to claim 9, wherein sending an indication of a web address to the user device comprises sending a text message to the user device, the text message containing the web address.

11. A method according to claim 8, wherein the identifier of the user device is a MAC address of the user device.

12. An apparatus for processing a mobile payment transaction comprising:
a computer processor and a data storage device, the data storage device having a mobile wallet payment authorization component comprising non-transitory instructions operative by the processor to:
receive a mobile payment authorization request, the mobile payment authorization request indicating authentication information and an identifier of a payment card associated with the transaction, the authentication information comprising a device identifier of a payer device;
compare the authentication information with stored authentication information associated with the payment card; and
generate an authorization message for the mobile payment if the authentication information matches the stored authentication information associated with the payment card.

13. An apparatus according to claim 12, wherein the identifier of the payer device is a MAC address of the payer device.

14. An apparatus according to claim 12, wherein the mobile payment request is formatted according to the ISO-8583 standard.

15. An apparatus according to claim 14, wherein the device identifier of the payer device is indicated in a data field of the mobile payment authorization request configured for private use.

16. An apparatus according to claim 15, wherein the data field is any one of data fields 61 to 63, or 120 to 127 defined by the ISO-8583 standard.

17. An apparatus according to claim 12, wherein the mobile wallet payment authorization component further comprises non-transitory instructions operative by the processor to:
generate a fraud alert if the authentication information does not match the stored authentication information associated with the payment card.

18. An apparatus according to claim 12, further comprising storage for authentication data for a plurality of payment cards, wherein the stored authentication information associated with a payment card comprises an identifier of a first device marked as active and an identifier of a second device marked as non-active.

19. An apparatus according to claim 16, wherein the mobile wallet payment authorization component comprises non-transitory instructions operative by the processor to: compare the identifier of the payer device with the identifier of the first device.

20. An apparatus according to claim 12, further comprising a mobile wallet registration component comprising non-transitory instructions operative by the processor to:
receive a mobile wallet registration request from a user device, the mobile wallet registration request comprising an identifier of a payment card to be associated with the mobile wallet;
determine a device identifier of the user device; and
store the device identifier of the user device as authentication information associated with the payment card.

21. An apparatus according to claim 20, wherein the instructions to determine a device identifier of a user device comprise instructions to send an indication of a web address to the user device and determine the device identifier of the user device as the identifier of a device visiting the web address.

22. An apparatus according to claim 21, wherein the instructions to send an indication of a web address to the user device comprise instructions to send a text message to the user device, the text message containing the web address.

23. An apparatus according to claim 20, wherein the identifier of the user device is a MAC address of the user device.
